(19) United States
(12) Patent Application Publication
(10) Pub. No.: US 2020/0317467 A1
(43) Pub. Date: Oct. 8, 2020

(54) SHAFT SWITCHING ASSEMBLY FOR AN ELEVATOR SYSTEM

(71) Applicants: thyssenkrupp Elevator AG, Essen (DE); ThyssenKrupp AG, Essen (DE)

(72) Inventors: Richard THUM, Kornwestheim (DE); Marius MATZ, Filderstadt (DE); Eduard STEINHAUER, Nürtingen (DE)

(73) Assignees: thyssenkrupp Elevator AG, Essen (DE); ThyssenKrupp AG, Essen (DE)

(21) Appl. No.: 16/303,817

(22) PCT Filed: May 18, 2017
(86) PCT No.: PCT/EP2017/061963

§ 371 Date: Nov. 21, 2018

(30) Foreign Application Priority Data
May 23, 2016 (DE) 10 2016 208 857.2

(51) Int. Cl. B66B 1/24; B66B 9/00

(52) U.S. Cl. CPC B66B 1/2466; B66B 11/0407; B66B 9/003

(57) ABSTRACT

A shaft changing assembly may be utilized with or in an elevator system. The elevator system may include two vertical elevator shafts, cars that are independently movable in the elevator shafts, a horizontal guide rail connecting the elevator shafts and configured to guide the cars along a movement path during a changing process from a first of the shafts to an end position in a second of the shafts. The shaft changing assembly may comprise an auxiliary brake configured to generate a braking force to brake the car undergoing horizontal travel. Application of the braking force may depend on a velocity profile of the car undergoing horizontal travel.

### TECHNICAL FIELD

The invention relates to a shaft changing assembly for an elevator system as well as an elevator system with such a shaft changing assembly.

### PRIOR ART

So-called multi-elevator systems, for which the drive unit according to the invention is particularly suitable, comprise at least two elevator shafts, wherein at least a first vertical guide rail is present in each of the elevator shafts for the vertical guidance of a car. At least one car, in particular a plurality of cars, is provided, which can travel independently of one another along the guide rail in an elevator shaft. In order to enable a paternoster-type changing of the cars, a shaft changing assembly is provided by means of which a car is moved from one elevator shaft to another elevator shaft. During this transfer, the car negotiates a horizontal distance. During this horizontal travel, anyone present in the car is subjected to transverse accelerations, which are experienced as being uncomfortable as compared to the vertical accelerations usually occurring in the elevator operation, and after a certain threshold value they are even dangerous, since the persons are hurled uncontrollably in the car under the action of the horizontal acceleration.

Thus, it has already been proposed to enable the horizontal travel only when the cars are empty of people, although this has certain drawbacks. A person who refuses to get out may shut down an entire elevator system, because this also hinders the operation of all the following cars.

### SUMMARY OF THE INVENTION

The problem which the present invention proposes to solve is to find a solution for the abovementioned problems. The problem of the invention is solved by a shaft changing assembly as well as an elevator system according to the main claims; preferred embodiments will emerge from the dependent claims as well as the description.

The shaft changing assembly according to the invention is suitable for an elevator system of the kind mentioned above. The shaft changing assembly comprises an auxiliary brake, which is designed to generate a braking force in order to brake the car, wherein the use of the braking force depends on the curve of the velocity profile of the car.

The auxiliary brake is designed in particular to limit the transverse acceleration at the end of the changing process upon reaching the second elevator shaft, especially upon coming up against a horizontal stop upon reaching the second elevator shaft, to a predetermined maximum value. If the velocity at a predetermined location is greater than or equal to a preset value, the auxiliary brake will generate a braking force.

Thus, the shaft changing assembly may comprise a horizontal stop, wherein the auxiliary brake is designed to brake the car before striking the horizontal stop. It is enough for the auxiliary brake to reduce the velocity with which the car strikes against the horizontal stop; a total braking before the impact is advantageous, but not absolutely necessary.

The shaft changing assembly comprises in particular an additional service brake, which is designed to specifically brake the car during the horizontal travel, wherein the auxiliary brake is designed to bring about a slowing down of the car upon malfunction of the service brake. In particular, the auxiliary brake is a kind of emergency brake, which needs to provide a braking action when the service brake is not working properly.

Preferably, the auxiliary brake is designed to apply a braking force to the car if the velocity of the car in a given position is greater than a preset value and/or a deceleration of the car in a given position is less than a preset value. With the monitoring of this parameter of the velocity and/or deceleration in a given position, the proper working of the service brake can be monitored. If at least one of the mentioned conditions is not fulfilled, a malfunctioning of the service brake is to be assumed, so that the auxiliary brake will be used.

The auxiliary brake may be designed to apply a braking force earlier and/or more strongly to the car as the velocity (v) of the car (3) is greater in a given position.

In one possible embodiment, the auxiliary brake comprises at least one first magnetic element, which is situated along the travel path and which is designed to provide, in concert with at least one second magnetic element arranged on the car, a braking force which is greater as the velocity of the car is greater and/or as the car is closer to the end position in the second elevator shaft.

In particular, the second magnetic element arranged on the car is a armature magnet of a linear drive for driving the car. In particular, the first magnetic element is an eddy current element, in particular comprising a soft iron element, wherein the second magnetic element generates an eddy current within the first magnetic element.

The first magnetic element may comprise a coil, wherein the second magnetic element generates an electric current flow inside the coil. This generated current flow may be taken in defined manner through a resistor circuit (e.g., a resistor or an arrangement of resistors), whereby the braking force is generated.

The resistor circuit may comprise a voltage-dependent resistance value. In this case, the resistors may be switched on depending on the voltage. Since the voltage runs substantially equal to the velocity of the car, the velocity dependency can be produced by the voltage dependency.

The coil may be statically switched with the resistor circuit; alternatively, the coil may be dynamically switched with the resistor circuit; the resistors may then be switched on or off in defined manner, especially controlled by a control unit. The switching on may occur through power switches, such as relays or thyristors.

Alternatively, the current flow may be used for energy recuperation and feeding back into the power supply grid of the elevator system.

A magnetic element need not necessarily be a permanently magnetized element, but rather a fundamental magnetizability is sufficient, as in the case of a soft iron core. Preferably, the first or the second magnetic element acts in a magnetizing manner on the respective other magnetic element, i.e., the second or first one.

The invention moreover relates to an elevator system comprising at least two vertical elevator shafts, a least one car, in particular a plurality of cars, which can be moved in the elevator shafts independently of one another, a horizontal guide rail, by which the at least two vertical elevator shafts can be connected together, and which is designed to guide the car along a movement path during a changing process from a first of the elevator shafts to an end position in the second of the elevator shafts. Moreover, the elevator system comprises a shaft changing assembly of the abovedescribed kind.

### BRIEF DESCRIPTION OF THE DRAWINGS

The invention shall now be explained more closely with the aid of the figures, which show

FIG. 1 parts of an elevator system with a shaft changing assembly, in which the invention can be implemented;

FIG. 2 a velocity curve (FIG. 2a) and a curve of the absolute acceleration (FIG. 2b) of the car during a horizontal changing process;

FIG. 3 an auxiliary brake in a first embodiment;

FIG. 4 an auxiliary brake in a second embodiment;

FIG. 5 an auxiliary brake in a third embodiment;

FIG. 6 an auxiliary brake in a fourth embodiment;

FIG. 7 curve of the resistance values along the movement path in the embodiments of FIGS. 3 to 6;

FIG. 8 an auxiliary brake in a fifth embodiment;

FIG. 9 an auxiliary brake in a sixth embodiment.

### DESCRIPTION OF THE PREFERRED EMBODIMENTS

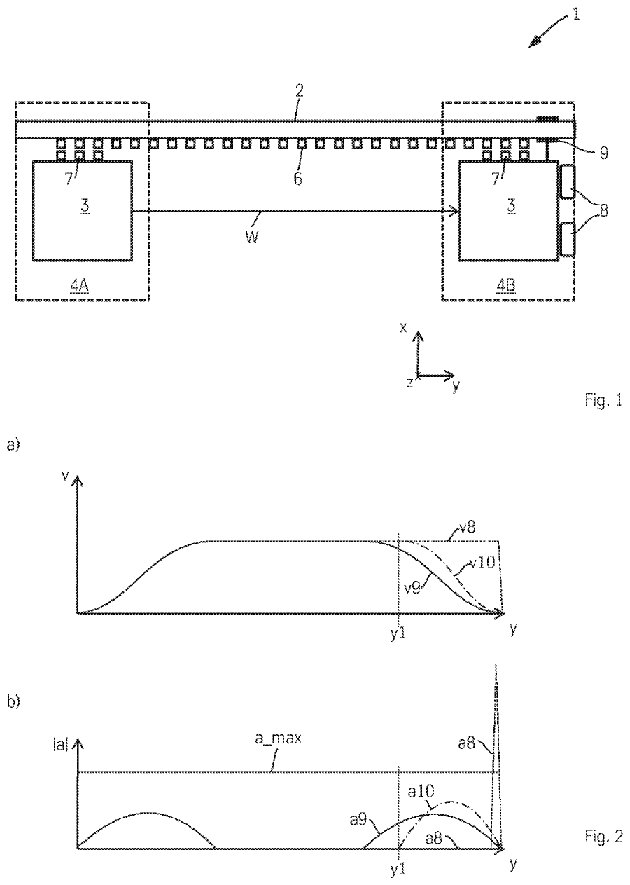

FIG. 1 schematically shows a shaft changing assembly 1, using a multi-elevator system. One can see two vertical elevator shafts 4A, 4B, seen from above, in each of which a car is shown. The two vertical elevator shafts 4 are interconnected by a horizontal guide rail 2. Thanks to guiding means, not shown, especially guide rollers, the car 3 can be moved from the first vertical elevator shaft 4A to the second vertical elevator shaft 4B.

The car 3 is driven by a linear motor layout, which comprises stator coils 6 firmly installed on the guide rail 2 and armature magnets 7, especially permanent magnets, firmly installed on the car 3. During the changing process, the car is moved along a movement path W, which is defined by the horizontal guide rail 2. In normal operation, the car 3 is braked by a service brake 9. The service brake 9 may be a show brake, for example, which interacts with the horizontal guide rail 2. Moreover, a stopping bumper 8 is provided, which defines a horizontal end position of the car 3 in the second elevator shaft 4B. The horizontal guide rail need not be oriented exactly horizontally; a horizontal directional component is sufficient, since in this way horizontal accelerations may already occur. Thus, a horizontal guide rail is oriented deviating from the exactly vertical orientation. Accordingly, the movement path may also run on a slant.

FIG. 1a shows a curve of the velocity during the horizontal travel, FIG. 2b shows the curve of the absolute acceleration a in the horizontal direction to which the car 3 and the persons contained therein are subjected. In normal operation, represented by the solid lines v9 and a9, the acceleration is distinctly below a maximum value a_max; the deceleration of the car in this case is produced by the service brake 9. Horizontal accelerations in this range of values constitute no danger for the persons in the interior of the car. However, if the service brake 9 should fail or be faulty in its operation (malfunction), the gentle deceleration at the end of the changing process may be absent and the car 3 will be braked abruptly by the stop 8 at the end of the horizontal movement.

The velocity curve v8 or the curve of the absolute acceleration a8 during malfunctioning operation is shown by the broken lines in FIGS. 2a and 2b. The acceleration a8 briefly increases upon impacting against the stopping bumper to a value which is significantly above the maximum acceleration a_max. Persons in the interior of the car 3 will be suddenly thrown against the wall of the car and might become severely injured.

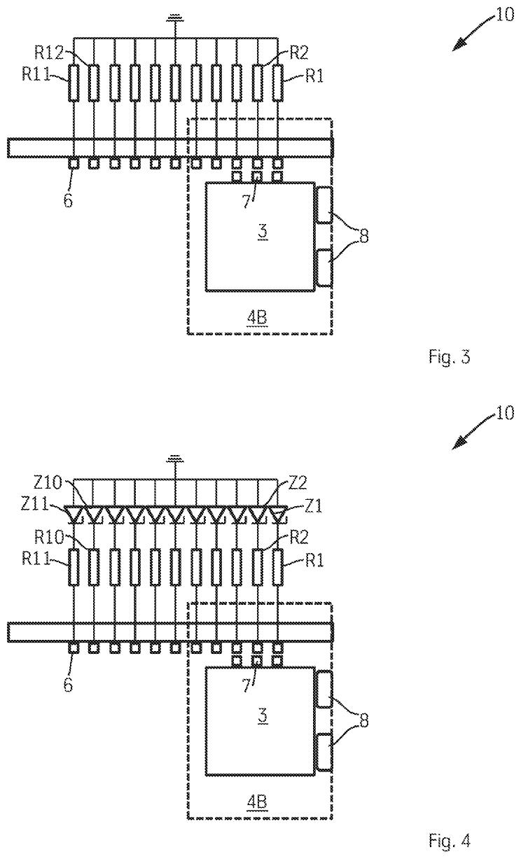

In order to guarantee the safety of the passengers during the faulty operation, a auxiliary brake 10 is provided, which shall be explained more closely below with the aid of FIGS. 3 to 7. This auxiliary brake 10 brings about a deceleration of the car 3 in the event that the service brake 9 is not used in a timely manner. As shown in FIG. 2, upon failure of the service brake 9 the velocity of the car 3 at first follows the curve v8. At position y1, v8 is greater than v9, where the value for v9 represents a preset value at position y1, which has now been exceeded v8. The auxiliary brake 10 is now activated.

In FIGS. 2a and 2b, the curve of the velocity v10 and the absolute acceleration a10 is shown by dot and dash line, which curve is generated by the engagement of the auxiliary brake 10. The absolute acceleration a10 now continues to remain below the maximum value a_max, since an unhindered impact against the stopping bumper 8 is prevented. Largely similar to this, the application of the auxiliary brake may also be contingent upon no adequate deceleration being recognized at position y1 (e.g., value a9 at y1).

FIG. 3 shows a first embodiment of the auxiliary brake 10. Components of the auxiliary brake 10 in the present instance can be the armature magnets 7 and the stator coils 6 of the linear motor layout; there may also be separate magnetic elements which are not used as a drive layout. The stator coils 6 are switched together with resistors R1 . . . R12. If during the horizontal travel of the car 3 the armature magnets 7 induce a current flow in the stator coils 6, this is conducted through the resistors R. In this way, a braking force is once again fed back to the magnets 7, so that a braking force is generated on the car 3. The higher the velocity of the car 3, the greater the current flow induced in the coils. With the higher current flow, the power loss likewise increases in the resistors, and finally the braking power increases ultimately in dependence on the velocity of the car.

FIG. 4 shows a second exemplary embodiment, based largely on the exemplary embodiment of FIG. 3; accordingly, only the differences shall be discussed below. In series with the resistors R1 . . . R11 is switched a Z-diode, which enables or prevents a flow through it depending on the voltage in the blocking direction. Only above a limit voltage present on the diode is a flow of current made possible. Here as well, the braking action occurs only when the kinetic energy is converted into power loss of the electrical components. As long as no voltage is induced in the resistors, neither can any energy conversion be transformed by the resistors and hence no braking action can be generated. The voltage imposed at the Z-diode increases with the velocity of the car 3; the braking action sets in at high velocity of the car.

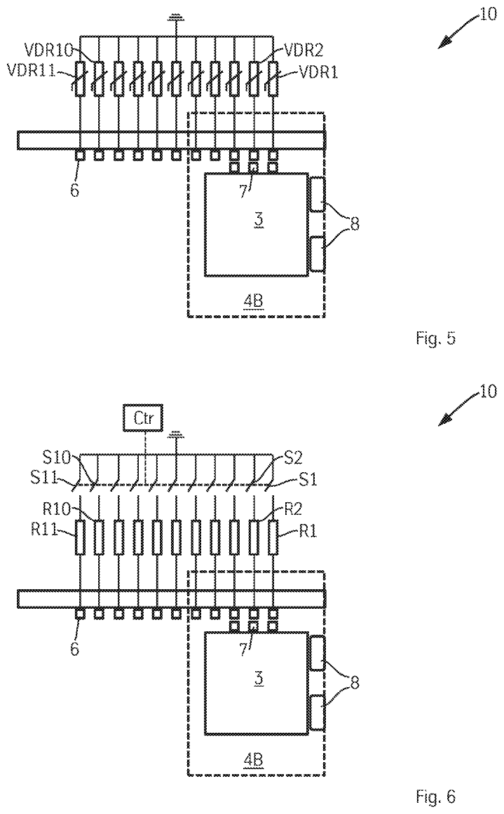

FIG. 5 shows a third exemplary embodiment, representing an alternative to the second exemplary embodiment of FIG. 4. Only the differences from the second exemplary embodiment shall be described. In place of the series circuit of resistor and Zehner diode each time a resistance-dependent resistor VDR is switched directly with the individual coils 6.

By the choice of suitable voltage-dependent resistors VDR 1 . . . VDR 11 (FIG. 5) or suitable series circuits of resistors R1 . . . R11 and Z-diodes Z1 . . . Z11 (FIG. 4), the braking force can be set in dependence on the velocity of the car.

FIG. 6 shows a fourth exemplary embodiment, based largely on the exemplary embodiment of FIG. 3; accordingly, only the differences shall be discussed below. The resistors R here are specifically switched in with the aid of a control unit CTR. For this, the control unit CTR is interconnected with switches S1 . . . S11, which can specifically turn the resistors R on or off. Such switches S may be relays, thyristors, or other power switches.

FIG. 7 shows as an example one possible design ratio of the individual resistance values of the resistors R of the preceding figures (which can also be applied analogously to the voltage-dependent resistors VDR of FIG. 5), in order to achieve a deceleration profile a10 per FIG. 2b. The absolute values may of course be adapted among other things to the size, the maximum weight and the operating velocity of the car 3 during the changing process.

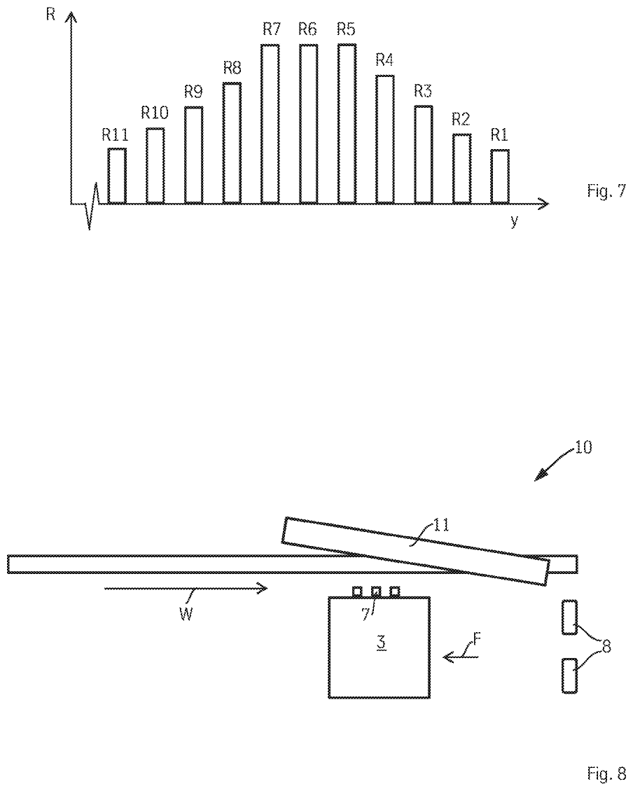

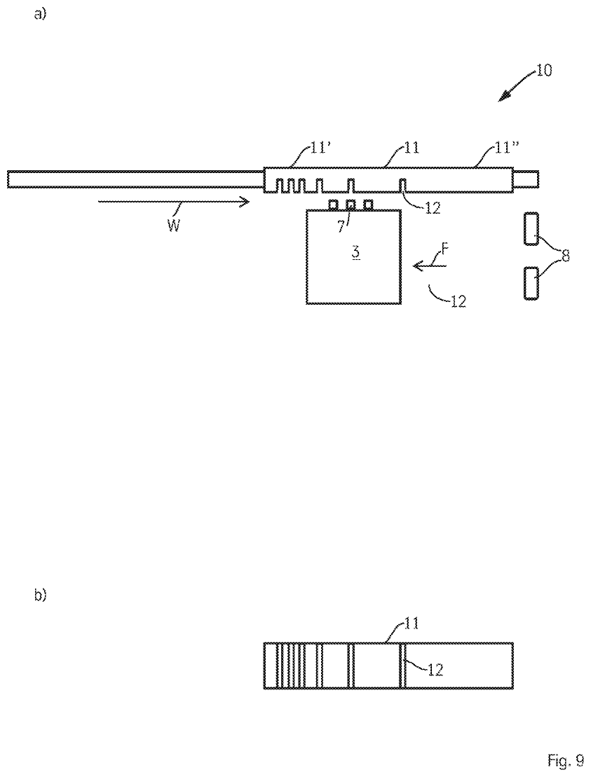

FIG. 8 shows a fifth exemplary embodiment, based largely on the first exemplary embodiment of FIG. 3; accordingly, only the differences shall be discussed below. However, the auxiliary brake makes do without any stator coils 6. The armature magnets 7 here interact with a stationary installed soft iron core 11. This soft iron core 11 is arranged such that a greater interaction with magnets 7 of the car is accomplished the closer the car is to its horizontal end position (defined by the end stops 8). Basically, the soft iron core comes closer to the armature magnets 7 as the travel path W increases. Thanks to the armature magnets 7, an eddy current is generated inside the soft iron core 11, being dependent on the velocity. The greater the velocity of the car, the greater the braking action exerted by the eddy current on the magnets and thus on the car.

FIG. 9 shows a sixth exemplary embodiment, based largely on the fifth exemplary embodiment of FIG. 8; accordingly, only the differences shall be discussed below. The soft iron core 11 has a defined arrangement of slots 12, which influence the forming of an eddy current inside the soft iron core 11. In a first region 11′, situated further in front in the direction of the movement path W, the density of the slots is relatively large. Due to the dense arrangement of the slots, the formation of the eddy current is diminished and therefore a relatively slight braking action is achieved. In a second region 11″, situated further back in the direction of the movement path W, the slot density is relatively slight. Due to the decreased arrangement of slots, the formation of the eddy current in the soft iron core 11 is intensified; hence, a large braking action can be accomplished, even at rather low velocity of the car.

FIG. 9a shows the auxiliary brake 10 from above; FIG. 9b shows the soft iron core 11 from the side, in detail. The fifth embodiment and the sixth embodiment may be combined; i.e., the soft iron core 11 of FIG. 8 may include the arrangement of slots 12 from FIG. 9.

### LIST OF REFERENCE NUMBERS

1 Shaft changing assembly
2 Horizontal guide rail
3 Car
4 Vertical elevator shaft
6 Stator coils
7 Armature magnets
8 Mechanical stop
9 Service brake
10 Auxiliary brake
11 Eddy current element
12 Slots
W Movement path
y Horizontal direction
v8 Velocity profile of car when braked by stopping bumper
a8 Acceleration profile of car when braked by stopping bumper
v9 Velocity profile of car by service brake
a9 Acceleration profile of car by service brake
v10 Velocity profile of car by auxiliary brake
a10 Acceleration profile of car by auxiliary brake
a_max Maximum allowable acceleration

1.-14. (canceled)

15. A shaft changing assembly for an elevator system that comprises a first elevator shaft; a second elevator shaft; cars that can be moved in the first and second elevator shafts independently of one another; and a horizontal guide rail by which the first and second elevator shafts are connected, the horizontal guide rail being configured to guide the cars along a movement path during horizontal travel during a changing process from the first elevator shaft to an end position in the second elevator shaft, wherein the shaft changing assembly comprises an auxiliary brake configured to generate a braking force to brake the cars during horizontal travel, wherein application of the braking force depends on a velocity profile of the car undergoing horizontal travel.

16. The shaft changing assembly of claim 15 comprising a horizontal stop, wherein the auxiliary brake is configured to brake the car undergoing horizontal travel before the car undergoing horizontal travel strikes the horizontal stop.

17. The shaft changing assembly of claim 15 comprising a service brake configured to brake the car undergoing horizontal travel, wherein the auxiliary brake is configured to slow down the car undergoing horizontal travel upon malfunction of the service brake.

18. The shaft changing assembly of claim 15 wherein the auxiliary brake is configured to apply the braking force to the car undergoing horizontal travel if during horizontal travel at least one of
a velocity of the car undergoing horizontal travel in a given position is greater than a preset value; or
a deceleration of the car undergoing horizontal travel in a given position is less than a preset value.

19. The shaft changing assembly of claim 15 wherein the auxiliary brake is configured to apply a first braking force when a velocity of the car undergoing horizontal travel exceeds a predetermined amount at a given position, wherein the auxiliary brake is configured to apply a second braking force when the velocity of the car undergoing horizontal travel is at or below the predetermined amount at the given position, wherein at least one of
the first braking force is applied comparatively earlier than the second braking force; or
the first braking force is greater than the second braking force.

20. The shaft changing assembly of claim 15 wherein the auxiliary brake comprises a first magnetic element disposed along the movement path, wherein the car undergoing horizontal travel comprises a second magnetic element configured to engage with the first magnetic element, wherein the braking force applied by the auxiliary brake increases with at least one of a velocity of the car undergoing horizontal travel or a proximity of the car undergoing horizontal travel to the end position.

21. The shaft changing assembly of claim 20 wherein the second magnetic element is an armature magnet of a linear drive for driving the car undergoing horizontal travel.

22. The shaft changing assembly of claim 20 wherein the first magnetic element is an eddy current element, wherein the second magnetic element is configured to generate an eddy current within the first magnetic element.

23. The shaft changing assembly of claim 20 wherein the first magnetic element comprises a coil, wherein the second magnetic element is configured to generate a current flow inside the coil.

24. The shaft changing assembly of claim 23 wherein a current flow induced by the coil is conducted through a resistor circuit.

25. The shaft changing assembly of claim 24 wherein the resistor circuit comprises a voltage-dependent resistance value.

26. The shaft changing assembly of claim 24 wherein the coil is configured to be statically switched with the resistor circuit.

27. The shaft changing assembly of claim 24 wherein the coil is configured to be dynamically switched with the resistor circuit.

28. An elevator system comprising:
a first elevator shaft;
a second elevator shaft;
cars that can be moved in the first and second elevator shafts independently of one another;
a horizontal guide rail by which the first and second elevator shafts are connected, the horizontal guide rail being configured to guide the cars along a movement path during horizontal travel during a changing process from the first elevator shaft to an end position in the second elevator shaft; and
a shaft changing assembly that includes an auxiliary brake configured to generate a braking force to brake the cars during horizontal travel, wherein application of the braking force depends on a velocity profile of the car undergoing horizontal travel.

29. The elevator system of claim 28 comprising a horizontal stop, wherein the auxiliary brake is configured to brake the car undergoing horizontal travel before the car undergoing horizontal travel strikes the horizontal stop.

30. The elevator system of claim 28 wherein the auxiliary brake is configured to apply the braking force to the car undergoing horizontal travel if during horizontal travel at least one of
a velocity of the car undergoing horizontal travel in a given position is greater than a preset value; or
a deceleration of the car undergoing horizontal travel in a given position is less than a preset value.

31. The elevator system of claim 28 wherein the auxiliary brake is configured to apply a first braking force when a velocity of the car undergoing horizontal travel exceeds a predetermined amount at a given position, wherein the auxiliary brake is configured to apply a second braking force when the velocity of the car undergoing horizontal travel is at or below the predetermined amount at the given position, wherein at least one of
the first braking force is applied comparatively earlier than the second braking force; or
the first braking force is greater than the second braking force.

32. The elevator system of claim 28 wherein the auxiliary brake comprises a first magnetic element disposed along the movement path, wherein the car undergoing horizontal travel comprises a second magnetic element configured to engage with the first magnetic element, wherein the braking force applied by the auxiliary brake increases with at least one of a velocity of the car undergoing horizontal travel or a proximity of the car undergoing horizontal travel to the end position.

33. The elevator system of claim 32 wherein the second magnetic element is an armature magnet of a linear drive for driving the car undergoing horizontal travel.

34. The elevator system of claim 32 wherein the first magnetic element is an eddy current element, wherein the second magnetic element is configured to generate an eddy current within the first magnetic element.
